(19) United States
(12) Patent Application Publication
(10) Pub. No.: US 2025/0306836 A1
(43) Pub. Date: Oct. 2, 2025

(54) ELECTRONIC DEVICE, CONTROL METHOD, AND STORAGE MEDIUM

(71) Applicant: Lenovo (Beijing) Limited, Beijing (CN)

(72) Inventor: Zhonghua CHEN, Beijing (CN)

(21) Appl. No.: 19/092,711

(22) Filed: Mar. 27, 2025

(30) Foreign Application Priority Data
Mar. 28, 2024 (CN) 202410370742.7

(51) Int. Cl. G06F 3/14

(52) U.S. Cl. CPC G06F 3/1407

(57) ABSTRACT

Electronic device includes: first interface configured to connect to first device; second interface configured to connect to second device; processing module, which is connected to the stated first interface and second interface and is capable of determining the data transmission mode of the first interface based on the connection status of the first interface and the first device. If the first interface is in a first data transmission mode, the stated processing module is also configured to adjust the second interface to be in a second data transmission mode. The difference between the stated first date transmission mode and the stated second data transmission mode is that the data transmission direction is different.

### CROSS-REFERENCE TO RELATED APPLICATION

The present disclosure claims priority to Chinese Patent Application No. 202410370742.7, filed on Mar. 28, 2024, the entire content of which is incorporated herein by reference.

### TECHNICAL FIELD

The present disclosure is related to an electronic device and control method.

### BACKGROUND

The display ports of a display often have fixed modes, including either an input port or an output port. The input port is only configured to connect to the host to receive display signals from the host. Similarly, the output port is only configured to connect to a second display to output the display signals to the second display.

When a user fails to distinguish between the input and output modes of display ports, it is easy to misconnect the input port and output port, resulting in the display being unable to display content. To ensure proper display functionality, a user must identify the correct modes of display port to correctly connect to the input port and output port. This process is complicated, with low efficiency.

### SUMMARY

In accordance with the present disclosure, there is provided an electronic device. The electronic device includes: a first interface, connected to a first device; a second interface, connected to a second device; and a processing module, connected to the first interface and the second interface and is capable of determining a data transmission mode of the first interface based on a connection status of the first interface and the first device. In response to the first interface being in a first data transmission mode, the processing module is configured to adjust the second interface to be in a second data transmission mode. A difference between the first date transmission mode and the second data transmission mode includes a difference in data transmission direction.

In accordance with the present disclosure, there is also provided a control method, performed by an electronic device. The method includes obtaining a connection status of a first interface and a second interface of the electronic device, the first interface being connected to a first device and the second interface being connected to a second device; based on the connection status of the first interface and the first device, determining a data transmission mode of the first interface through the processing module, the processing module being connected to the first interface and the second interface; adjusting the second interface to be in a second data transmission mode when the first interface is in a first data transmission mode. A difference between the first data transmission mode and the second data transmission mode includes a difference in data transmission direction.

In accordance with the present disclosure, there is also provided a non-transitory computer readable storage medium containing a computer program that, when being executed, causes at least one processor of an electronic device to perform: obtaining a connection status of a first interface and a second interface of the electronic device, the first interface being connected to a first device and the second interface being connected to a second device; based on the connection status of the first interface and the first device, determining a data transmission mode of the first interface through the processing module, the processing module being connected to the first interface and the second interface; adjusting the second interface to be in a second data transmission mode when the first interface is in a first data transmission mode. A difference between the first data transmission mode and the second data transmission mode includes a difference in data transmission direction.

### BRIEF DESCRIPTION OF THE DRAWINGS

To more clearly illustrate the technical solution of the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts and may be encompassed in the present disclosure.

FIG. 1 illustrates a schematic structural diagram of an electronic device according to some embodiments of the present disclosure.

FIG. 2 illustrates a schematic diagram of data transmission direction according to some embodiments of the present disclosure.

FIG. 3 illustrates another schematic diagram of data transmission direction according to some embodiments of the present disclosure.

FIG. 4 illustrates a flow chart of a control method according to some embodiments of the present disclosure.

### DETAILED DESCRIPTION OF THE EMBODIMENTS

Here, various aspects, features, and embodiments of the present disclosure are described in view of the accompanying drawings.

It should be understood that various modifications may be made to the embodiments described herein. Therefore, the present disclosure should not be considered as a limitation, but merely as an example of the embodiments. Those skilled in the art will consider other modifications, which are encompassed within the scope and spirit of the present disclosure.

The accompanying drawings, which are incorporated herein and constitute a part of the specification, illustrate embodiments of the present disclosure and, together with the general description of the disclosure given above, and the detailed description of the embodiments given below, serve to explain the principles of the present disclosure.

By the following description of the preferred embodiments given as non-limiting examples with reference to the accompanying drawings, these and other features of the present disclosure will become apparent and encompassed within the scope of the present disclosure.

It should also be understood that, although the present disclosure has been described with reference to some specific examples, those skilled in the art will undoubtedly be able to implement many other equivalent forms of the present disclosure, which will have the characteristics as described in the claims and therefore fall within the scope of protection defined thereby.

The above and other aspects, features and advantages of the present disclosure will become more apparent in view of the following detailed description when taken in conjunction with the accompanying drawings.

Specific embodiments of the present disclosure will be described below with reference to the accompanying drawings.

It should be understood that the embodiments described are merely examples of the present disclosure, which can be implemented in various ways. Well-known and/or repetitive functions and structures are not described in detail to avoid unnecessary or excessive details that may obscure the present application. Therefore, the specific structural and functional details described herein are not intended to be limited, but are merely provided as a basis for the claims and as representative examples to teach those skilled in the art to use the present disclosure in substantially any suitable detailed structure.

This specification may use the phrases “in one embodiment”, “in another embodiment”, “in yet another embodiment” or “in other embodiments”, any of which may refer to one or more of the same or different embodiments according to the present disclosure.

The electronic device provided in the embodiments of the present disclosure can automatically control the data transmission mode of the first interface and the second interface, and ensure that the first interface and the second interface effectively perform data transmission. Thus, there is no need for the user to manually distinguish/identify the data transmission mode of the interfaces, achieving simple operation and high user experience. Further, there is no need to switch the devices connected to the first interface and the second interface, which improves data transmission efficiency.

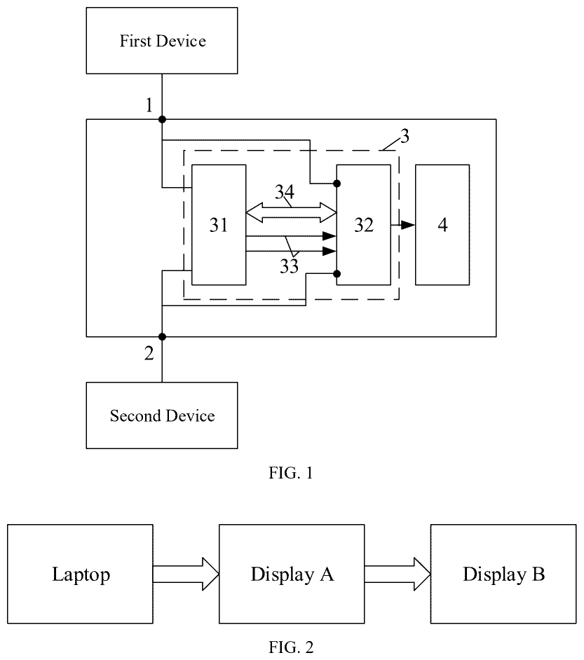

FIG. 1 illustrates a schematic structural diagram of an exemplary electronic device provided according to the embodiment of the present disclosure. As shown in FIG. 1, the electronic device includes a first interface 1, a second interface 2, and a processing module 3. The electronic device is a display device. The first interface 1 and/or the second interface 2 can be set as a Video Graphics Array (VGA) interface, a Digital Video Interface (DVI), a High Definition Multimedia Interface (HDMI), a DisplayPort (DP) and/or a Universal Serial Bus (USB) interface such as Type-C.

In one embodiment, the first interface 1 is configured to connect to a first device, and the second interface 2 is configured to connect to a second device. Of course, the electronic device can be connected solely to the first device or solely to the second device. Alternatively, the electronic device can be connected to the first device and the second device at the same time.

In FIG. 1, the processing module 3 is connected to the first interface 1 and the second interface 2, and the processing module 3 is able to determine the data transmission mode of the first interface 1 based on the connection status of the first interface 1 and the first device.

For example, the processing module 3 can detect whether the electronic device is connected to the first device and/or the second device based on the hot-plug detection signals transmitted by the first interface 1 and the second interface 2.

If the first interface 1 is in the first data transmission mode, the processing module 3 is also configured to adjust the second interface 2 to be in the second data transmission mode. The difference between the first data transmission mode and the second data transmission mode is that the data transmission direction is different. For example, the first data transmission mode is for the electronic device to receive data transmitted by the external device (such as the first device and/or second device), and the second data transmission mode is for the electronic device to transmit data to the external devices (such as the first device and/or second device). Optionally, if the first data transmission mode is that the first interface 1 receives data transmitted from the first device to the electronic device, the second data transmission mode is that the second interface 2 transmits data to the second device. If the first data transmission mode is that the first interface 1 transmits data to the first device and the electronic device, the second data transmission mode is that the second interface 2 receives data transmitted by the second device.

Still in FIG. 1, the electronic device of the present embodiment further includes a display module 4, which is connected to the processing module 3 to output display data from the first device connected to the first interface 1. It is worth noting that while the first interface 1 is in the first data transmission mode, the second interface 2 can also be in the first data transmission mode, meaning that the second interface 2 receives data transmitted from the second device. At this time, the display module 4 outputs display data from the second device connected to the second interface 2. Of course, the display module 4 can also simultaneously output display data from the first device connected to the first interface 1 and display data from the second device connected to the second interface 2, etc., without limitations.

FIG. 2 illustrates a schematic diagram of data transmission direction. In some embodiments, the first device may include a laptop, and both the electronic device and the second device may include monitors, for example, including display A and display B. The first device is connected to the electronic device through the first interface 1, and the second device is connected to the electronic device through the second interface 2. The processing module 3 adjusts the first interface 1 to be in the first data transmission mode and adjusts the second interface 2 to be in the second data transmission mode. At this time, the processing module 3 controls the display module 4 to output the display data from the first device and transmits the display data to the second device. That is, after the first device, the laptop, transmits video data to the electronic device, the processing module 3 of the electronic device, which is display A, controls the display module 4 to display the video data transmitted by the laptop. At the same time, the processing module 3 transmits the video data through the electronic device to display B, so that display B displays the video data.

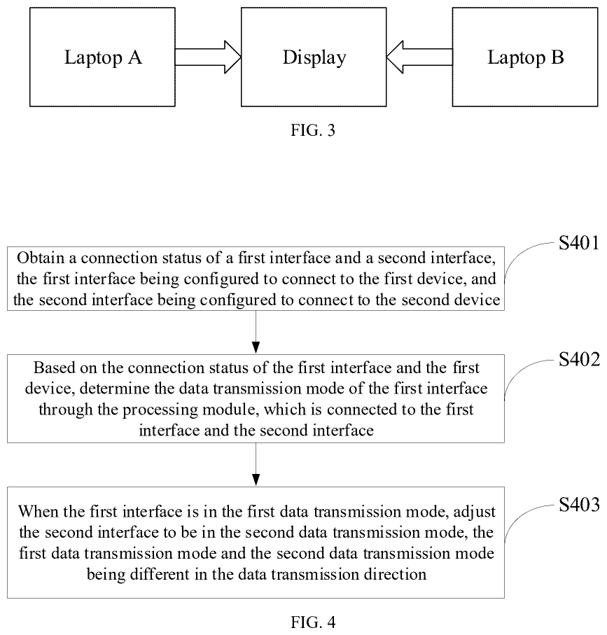

FIG. 3 illustrates another schematic diagram of data transmission direction. In some embodiments, the first device and the second device may both be laptops, for example, laptop A and laptop B, and the electronic device may be a display. As shown, the first device is connected to the electronic device through the first interface 1, and the second device is connected to the electronic device through the second interface 2. The processing module 3 adjusts the first interface 1 to be in the first data transmission mode and adjusts the second interface 2 to be in the first data transmission mode. At this time, the processing module 3 identifies the priority levels of the first device and the second device, and controls the display module 4 to output the display data from the first device and the second device according to their priority levels. That is, the processing module 3 obtains the priority level of laptop A through the first interface 1, and obtains the priority level of laptop B through the second interface 2. If video data transmitted by laptop A and laptop B is received at the same time, the processing module 3 can compare the priority levels of laptop A and laptop B. If the priority level of laptop A is higher than that of laptop B, the processing module 3 controls the display module 4 to first display the video data transmitted by laptop A, and then display the video data transmitted by laptop B. In another embodiment, if video data transmitted by laptop A and laptop B is received at the same time and the priority level of laptop A is higher than that of laptop B, the processing module 3 can also control the display module 4 to display the video data transmitted by laptop A in a larger display area, and the video data transmitted by laptop B in a smaller display area, etc., without limitations.

It is worth noting that if the processing module 3 detects that the second interface 2 is connected to the second device, the processing module 3 can first set the data transmission mode of the second interface 2 to the second data transmission mode. If data transmission from the second device to the electronic device is detected, the processing module 3 switches the second interface 2 from the second data transmission mode to the first data transmission mode to ensure normal communication between the electronic device and the second device without the need for manual adjustment, greatly enhancing the user's experience.

Moreover, the processing module 3 of the present disclosure includes a first processing unit 31 and a second processing unit 32. A first channel 33 is provided between the first processing unit 31 and the second processing unit 32. The first channel 33 is configured to transmit status signals sent from the first processing unit 31 to the second processing unit 32. Status signals include high-level signals and low-level signals.

In one embodiment, the electronic device includes a first interface 1 and a second interface 2. Based on this, the embodiment of the present disclosure sets the first channel 33 to include a first sub-channel and a second sub-channel to transmit the status signal corresponding to the first interface 1 through the first sub-channel, and to transmit the status signal corresponding to the second interface 2 through the second sub-channel, thereby avoiding the issue of incorrect transmission of status signals and ensuring the accuracy of the data transmission modes of the first interface 1 and the second interface 2.

The first processing unit 31 is connected to the first interface 1 and the second interface 2. The first processing unit 31 sends the status signal corresponding to the first interface 1 to the second processing unit 32 through the first sub-channel based on the connection status of the first interface 1 and the first device. The first processing unit 31 sends the status signal corresponding to the second interface 2 to the second processing unit 32 through the second sub-channel based on the connection status between the second interface 2 and the second device.

After receiving the status signal, the second processing unit 32 adjusts the status of a first pin and/or a second pin in the second processing unit 32 in response to the status signal. In one embodiment, the second processing unit 32 adjusts the status of the first pin based on the status signal corresponding to the first interface 1, and the second processing unit 32 adjusts the status of the second pin based on the status signal corresponding to the second interface 2. For example, if the status signal corresponding to the first interface 1 is a high-level signal, the second processing unit 32 adjusts the status of the first pin to be the transmitting end. If the status signal corresponding to the first interface 1 is a low-level signal, the second processing unit 32 adjusts the status of the first pin to be the receiving end.

Based on the connection between the first processing unit 31, and the first interface 1 and the second interface 2, the first processing unit 31 is configured to adjust the data transmission modes of the first interface 1 and the second interface 2. Specifically, the first processing unit 31 generates a status signal based on the connection status between the first interface 1 and the first device, and sends the status signal to the second processing unit 32, so that the second processing unit 32 responds to the status signal to adjust the status of the first pin, thereby achieving the purpose of adjusting the data transmission mode of the first interface 1. The process of adjusting the data transmission mode of the second interface 2 is similar to the process of adjusting the data transmission mode of the first interface 1, and will not be further elaborated in this embodiment of the present disclosure.

In FIG. 1, the first pin of the second processing unit 32 is connected to the first interface 1, and the second pin of the second processing unit 32 is connected to the second interface 2. If the first interface 1 is in the first data transmission mode, the second processing unit 32 controls the first interface 1 to receive data transmitted from the first device to the electronic device; if the second interface 2 is in the second data transmission mode, the second processing unit 32 controls the second interface 2 to transmit data to the second device. Of course, if the second interface 2 is in the first data transmission mode, the second processing unit 32 controls the second interface 2 to receive data transmitted from the second device to the electronic device.

In one embodiment, when the first device is a host device such as a computer, after the first device is connected to the first interface 1, the first device sends a handshake signal to the first interface 1. Correspondingly, the first processing unit 31 also responds to the handshake signal of the first device to establish a communication connection between the electronic device and the first device. Specifically, after the first processing unit 31 receives the handshake signal sent by the first device, the first processing unit 31 returns a response signal to the first device. This response signal includes at least an attribute information and communication information of the electronic device. After receiving the response signal returned by the electronic device, the first device implements a communication connection between the electronic device and the first device.

In one embodiment, the first device is a laptop and the electronic device is a display. The laptop sends a handshake signal to the first interface. After receiving the handshake signal sent by the first device, the first processing unit of the display returns a response signal to the laptop, generates a status signal, and sends the generated status signal to the second processing unit so that the second processing unit adjusts the status of the first pin, thereby enabling the laptop to use the display as an extended display.

In yet another embodiment, in some situations, even though multiple displays are connected in series, the user only needs one display as an extended screen for the laptop to display data. This could be a situation where the user wants to view clearer data while preventing data leakage. That is, if the electronic device is connected to the first device and the second device at the same time, the first processing unit 31 of the electronic device can determine the suitable display. If the suitable display is the second display, after receiving the handshake signal transmitted by the first device, the first processing unit 31 can directly transmit the handshake signal to the second device, so that the second device sends back its attribute information and communication information, thereby establishing a communication connection between the electronic device and the second device. For example, the first device is a laptop, and both the electronic device and the second device are displays, display A and display B. After receiving the handshake signal and communication requirements transmitted by the laptop, if display A recognizes that the communication requirement is to display data through a display with a high resolution, the first processing unit of display A compares its own resolution with the resolution of the second device. If the resolution of the second device is higher than its own, the first processing unit of display A transmits the handshake signal to the second device, so that the second device sends back its attribute information and communication information, thereby establishing a communication connection between the electronic device and the second device to meet the display requirements.

In FIG. 1, a second channel 34 is also provided between the first processing unit 31 and the second processing unit 32. If the second interface 2 is connected to the second device, the second processing unit 32 obtains the attribute information of the second device and sends a reset signal to the first processing unit 31 through the second channel 34. After receiving the reset signal, the first processing unit 31 responds to the reset signal and adjusts the data transmission mode of the first interface 1, so that the second processing unit 32 transmits the attribute information of the second device to the first device.

The reset signal carries the attribute information of the second device. When the second interface 2 is connected to the second device, the second processing unit 32 of the electronic device can send a retrieval signal to the second device through the second interface 2, so that the second device responds to the retrieval signal and reports its attribute information to the second processing unit 32 of the electronic device. After receiving the attribute information reported by the second device, the second processing unit 32 of the electronic device sends a reset signal to the first processing unit 31 through the second bidirectional transmission channel 34. After receiving the reset signal, the first processing unit 31 adjusts the data transmission mode of the first interface 1 to the second data transmission mode, meaning that the electronic device can transmit data to the first device through the first interface 1. Specifically, the first processing unit 31 sends a high-level signal to the second processing unit 32 through the first channel 33. The second processing unit 32 adjusts the state of the first pin to be the transmitting end. As a result, the second processing unit 32, through the first pin and the first interface 1, transmits the attribute information of the second device to the first device. This allows the first device, based on the received attribute information of the second device and the electronic device, to regenerate the handshake signal and resend the handshake signal to the electronic device, which in turn sends the handshake signal to the second device, thereby establishing a communication connection between the first device and the electronic device, as well as a communication connection between the first device and the second device.

Based on the same inventive concept, the second aspect of the present disclosure also provides a control method. Since the principle of the audio transmission device in this disclosure for solving the problem is similar to the electronic device described above, the implementation of the control method can be referred to the implementation of that method, and the repetition will not be addressed.

FIG. 4 illustrates a flow chart of a control method for embodiment of the present disclosure. Specific steps include S401-S403.
S401, obtaining a connection status of the first interface and the second interface, the first interface being configured to connect to the first device, and the second interface being configured to connect to the second device.
S402, based on the connection status of the first interface and the first device, determining the data transmission mode of the first interface through the processing module, which is connected to the first interface and the second interface.
S403, when the first interface is in the first data transmission mode, adjusting the second interface to be in the second data transmission mode. The difference between the first data transmission mode and the second data transmission mode is that the data transmission direction is different.

The embodiment of the present disclosure can determine the data transmission mode of the first interface based on the connection status of the first interface and the first device, and adjust the data transmission mode of the second interface accordingly. That is, the processing module can automatically control the data transmission mode of the first interface and the second interface, and ensure that the first interface and the second interface can effectively transmit data, without the need for the user to manually distinguish the data transmission modes of the interfaces. This results in simple operation and higher user experience. Additionally, there is no need to switch the devices connected to the first and second interfaces, which improves data transmission efficiency.

Embodiments of the present disclosure provide a storage medium. The storage medium is a computer-readable medium and stores a computer program. When the computer program is executed by a processor, the method provided by any embodiment of the present disclosure is implemented, including the following steps S11 to S13:
S11, obtaining the connection status of the first interface and the second interface. The first interface is configured to connect to the first device, and the second interface is configured to connect to the second device.
S12, based on the connection status of the first interface and the first device, determining the data transmission mode of the first interface through the processing module. The processing module is connected to the first interface and the second interface.
S13, when the first interface is in the first data transmission mode, adjusting the second interface to be in the second data transmission mode. The difference between the first data transmission mode and the second data transmission mode is that the data transmission direction is different.

The embodiment of the present disclosure can determine the data transmission mode of the first interface based on the connection status of the first interface and the first device, and adjust the data transmission mode of the second interface accordingly. That is, the processing module can automatically control the data transmission mode of the first interface and the second interface, and ensure that the first interface and the second interface can effectively transmit data, without the need for the user to manually distinguish the data transmission modes of the interfaces. This results in simple operation and higher user experience. Additionally, there is no need to switch the devices connected to the first and second interfaces, which improves data transmission efficiency.

In one embodiment, the above-mentioned storage medium may include but is not limited to: USB flash drives, read-only memory (ROM), random access memory (RAM), mobile hard drives, magnetic disks, optical disks, and/or other various media that can store program code. In one embodiment, the processor executes the method steps described in the above embodiment based on the program code stored in the storage medium. For specific examples in this embodiment, reference may be made to the examples described in the above-mentioned embodiments and optional implementations, and this embodiment will not be described again here. Clearly, those skilled in the art should understand that the above-mentioned modules or steps of the present disclosure can be implemented with a general-purpose computing device. They can be concentrated on a single computing device, or distributed on a network composed of multiple computing devices. Alternatively, they can be implemented with program codes executable by the computing device. Thus, they may be stored in a storage device for execution by a computing device, and in some cases, the steps shown or described may be performed in a sequence different from that herein, or may be implemented separately as individual integrated circuit modules, or as multiple modules or steps thereof may be implemented as a single integrated circuit module. As such, the application is not limited to any specific combination of hardware and software.

Furthermore, although exemplary embodiments have been described herein, their scope includes any and all embodiments based on this disclosure with equivalent elements, modifications, omissions, combinations (such as various cross-over embodiments), adaptations, or changes. The elements in the claims are to be construed broadly based on the language used in the claims, and are not limited to the examples described in this specification or during the practice of this disclosure. These examples are to be construed as non-exclusive. Therefore, this specification and examples are intended to be regarded merely as illustrative, and the true scope and spirit are indicated by the following claims and their full range of equivalents.

The above description is intended to be illustrative rather than restrictive. For example, the above examples (or one or more versions thereof) may be used in combination with each other. For example, other embodiments may be used by those of ordinary skill in the art upon reading the above description. Additionally, in the above detailed embodiments, various features may be grouped together to simplify the present disclosure. This should not be interpreted as an intention that an unclaimed disclosed feature is essential to any claim. Rather, the subject matter of this disclosure may lie in less than all features of a particular disclosed embodiment. Thus, the following claims are hereby incorporated as examples or embodiments, with each claim independently representing a separate embodiment, and these embodiments can be considered in various combinations or arrangements with each other. The scope of the disclosure should be determined with reference to the appended claims, along with the full scope of equivalents to which such claims are entitled.

Multiple embodiments of the present disclosure have been described in detail above, but the present disclosure is not limited to these specific embodiments. Those skilled in the art, based on the concepts of the present disclosure, can make various modifications and variations to the embodiment. These modifications and variations should all fall within the scope of protection claimed by the present disclosure.

What is claimed is:

1. An electronic device, comprising:
a first interface, connected to a first device;
a second interface, connected to a second device; and
a processing module, connected to the first interface and the second interface and is capable of determining a data transmission mode of the first interface based on a connection status of the first interface and the first device, wherein
in response to the first interface being in a first data transmission mode, the processing module is configured to adjust the second interface to be in a second data transmission mode, and
a difference between the first date transmission mode and the second data transmission mode includes a difference in data transmission direction.

2. The electronic device according to claim 1, further comprising:
a display module, connected to the processing module and outputting display data from the first device connected to the first interface and/or display data from the second device connected to the second interface.

3. The electronic device according to claim 1, wherein:
the processing module includes a first processing unit and a second processing unit;
a first channel is provided between the first processing unit and the second processing unit, and the first channel is configured to transmit status signals sent from the first processing unit to the second processing unit; and
in response to the status signals, the second processing unit is configured to adjust status of a first pin and/or a second pin in the second processing unit.

4. The electronic device according to claim 3, wherein:
the first processing unit is connected to the first interface and the second interface;
the first processing unit is configured to adjust data transmission modes of the first interface and the second interface; and
in response to a handshake signal of the first device,
the first processing unit is configured to establish a communication connection between the electronic device and the first device; and/or to transmit the handshake signal to the second device to establish a communication connection between the electronic device and the second device.

5. The electronic device according to claim 3, wherein:
the first pin of the second processing unit is connected to the first interface;
the second pin of the second processing unit is connected to the second interface;
the second processing unit controls the first interface to receive data transmitted from the first device to the electronic device; and
the second processing unit controls the second interface to transmit data to the second device or receive data transmitted from the second device to the electronic device.

6. The electronic device according to claim 3, wherein:
a second channel is provided between the first processing unit and the second processing unit;
in response to the second interface being connected to the second device,
the second processing unit obtains an attribute information of the second device and sends a reset signal to the first processing unit through the second channel;
the first processing unit responds to the reset signal and adjusts the data transmission mode of the first interface to enable the second processing unit to transmit the attribute information of the second device to the first device.

7. The electronic device according to claim 1, wherein:
in response to the second interface being connected to the second device and the second device transmitting data to the electronic device,
the processing module adjusts the second interface to switch from the second data transmission mode to the first data transmission mode.

8. The electronic device according to claim 7, wherein:
in response to the first interface and the second interface both being in the first data transmission mode,
the processing module identifies priority levels of the first device and the second device and,
the processing module controls the display module to output display data from the first device and the second device according to the priority levels of the first device and the second device.

9. The electronic device according to claim 2, wherein:
in response to the first interface being in the first data transmission mode and the second interface being in the second transmission mode,
the processing unit controls the display module to output display data from the first device and to transmit the display data to the second device.

10. A control method, performed by an electronic device, the method comprising:
obtaining a connection status of a first interface and a second interface of the electronic device, wherein the first interface is connected to a first device and the second interface is connected to a second device;
based on the connection status of the first interface and the first device, determining a data transmission mode of the first interface through the processing module, wherein the processing module is connected to the first interface and the second interface; and
adjusting the second interface to be in a second data transmission mode when the first interface is in a first data transmission mode, wherein
a difference between the first data transmission mode and the second data transmission mode includes a difference in data transmission direction.

11. The method according to claim 1, further comprising:
outputting display data from the first device connected to the first interface and/or display data from the second device connected to the second interface.

12. The method according to claim 10, wherein:
the processing module includes a first processing unit and a second processing unit;
a first channel is provided between the first processing unit and the second processing unit, and the first channel is configured to transmit status signals sent from the first processing unit to the second processing unit; and
in response to the status signals, the second processing unit is configured to adjust status of a first pin and/or a second pin in the second processing unit.

13. The method according to claim 12, wherein:
the first processing unit is connected to the first interface and the second interface;
the first processing unit is configured to adjust data transmission modes of the first interface and the second interface; and
in response to a handshake signal of the first device,
the first processing unit is configured to establish a communication connection between the electronic device and the first device; and/or to transmit the handshake signal to the second device to establish a communication connection between the electronic device and the second device.

14. The method according to claim 12, wherein:
the first pin of the second processing unit is connected to the first interface;
the second pin of the second processing unit is connected to the second interface;
the second processing unit controls the first interface to receive data transmitted from the first device to the electronic device; and
the second processing unit controls the second interface to transmit data to the second device or receive data transmitted from the second device to the electronic device.

15. The method according to claim 12, wherein:
a second channel is provided between the first processing unit and the second processing unit;
in response to the second interface being connected to the second device,
the second processing unit obtains an attribute information of the second device and sends a reset signal to the first processing unit through the second channel;
the first processing unit responds to the reset signal and adjusts the data transmission mode of the first interface to enable the second processing unit to transmit the attribute information of the second device to the first device.

16. The method according to claim 10, wherein:
in response to the second interface being connected to the second device and the second device transmitting data to the electronic device,
the processing module adjusts the second interface to switch from the second data transmission mode to the first data transmission mode.

17. The method according to claim 16, wherein:
in response to the first interface and the second interface both being in the first data transmission mode,
the processing module identifies priority levels of the first device and the second device and,
the processing module controls the display module to output display data from the first device and the second device according to the priority levels of the first device and the second device.

18. The method according to claim 11, wherein:
in response to the first interface being in the first data transmission mode and the second interface being in the second transmission mode,
the processing unit controls the display module to output display data from the first device and to transmit the display data to the second device.

19. A non-transitory computer readable storage medium containing a computer program that, when being executed, causes at least one processor of an electronic device to perform:
obtaining a connection status of a first interface and a second interface of the electronic device, wherein the first interface is connected to a first device and the second interface is connected to a second device;
based on the connection status of the first interface and the first device, determining a data transmission mode of the first interface through the processing module, wherein the processing module is connected to the first interface and the second interface; and
adjusting the second interface to be in a second data transmission mode when the first interface is in a first data transmission mode, wherein a difference between the first data transmission mode and the second data transmission mode includes a difference in data transmission direction.

20. The storage medium according to claim 19, wherein the at least one processor is further configured to performing:
outputting display data from the first device connected to the first interface and/or display data from the second device connected to the second interface.
